(19) United States
(12) Patent Application Publication
(10) Pub. No.: US 2001/0010060 A1
(43) Pub. Date: Jul. 26, 2001

(54) Electronics information transmission

(76) Inventors: Yueh-O Yu, Hsin-Chu City (TW); Hou-Te Lu, Taichung City (TW)

Correspondence Address: BACON & THOMAS, PLLC, 625 Slaters Lane, 4th Floor, Alexandria, VA, 22314-1176, US

(21) Appl. No.: 09/732,791

(22) Filed: Dec. 11, 2000

(30) Foreign Application Priority Data
Jan. 19, 2000 (TW) 089100848
Mar. 27, 2000 (TW) 089105612

(51) Int. Cl. G06F 15/16

(52) U.S. Cl. 709/245; 709/206

(57) ABSTRACT

A method and a system of the invention are for assisting a user in getting the new electronic information. The electronic mail provider actively provides identification information of a new electronic mail. Then users can get the message about arrival of a new electronic mail and its identification information without making any dial-up connection to the electronic mail provider. The invention can improve system and method of electronic mail provider for transferring electronic mails. The invention also can improve the method and system for users to get electronic mails. Furthermore, the invention can extends only to notify users having new electronic mails without providing complete identification information.

### BACKGROUND OF THE INVENTION

1. Field of the Invention

The present invention relates to transmission of electronic information, and particularly to a system and a method for transferring identification information of electronic mail.

2. Description of the Prior Art

Different from conventional mails penned in paper, electronic mails are for transferring and receiving messages by using some electronic devices. When users would like to send letters to others, they can key in letters by using any office editor, and transfer them through Internet. At the moment, receivers may be not in the state of on-line, that is, their computers can be not connected to Internet. In fact, all such electronic mails are stored in the mail servers in any Internet service provider (ISP). Users can receive their mails when they connects their computers with Internet next time and open their mail boxes in the mail server of Internet.

In accompanying with the population of mail service, human living is establishing closer relationship with electronic mails. In general, users need to first login Internet, and thereafter send and receive their electronic mails. In the present day, there are two methods for Internet log-in. First is shown in FIG. 1, clients (users) can actively make a caller connection by using a personal computer (PC) 10, and connect to an ISP 16 with a modem 12 through a telephone network 14. Second, clients themselves have Internet Protocol (IP) addresses that have all connection functions. However, by using methods above, clients can't know the latest new messages for their mails without entering into the Internet or connecting to the ISP. Plus, there are some disadvantages about these two methods above. First, users may waste their available caller time and phone bills if there are no new mails in their electronic mailbox. Furthermore, if users set up a periodic mail-receiving time by electronic mail software, that may result in the occupation of Internet.

Therefore, it is important for electronic mail service providers to provide the services for users to know the arrival of new mails in time and receive them as soon as possible.

### SUMMARY OF THE INVENTION

In accordance with the above description of the prior art, the present invention provides a system and method for helping users knowing the contents of their new electronic mails. The system and method of the present invention would be able to automatically transfer the Email Identification (EID) of an electronic mail, stored in a mail server of an electronic mails provider, to a receiver.

Another object of the invention is to provide a system and method for transferring electronic mails. Users can immediately know the arrival of their new mails without turning on computers and connecting to Internet, and therefore save network resources and time cost.

According to the above objects, the invention provides several embodiments of method and system for transferring electronic mails. In the present invention, as an electronic mail provider detects a new electronic mail, it then actively transmits a transmission signal to a receiving terminal assigned by user. Next, after the electronic mail provider receiving a response message from the receiving terminal, it transfers identification information of the electronic mail to the receiving terminal. Besides, the invention also provides a method and a system for displaying identification information of electronic mail on a mail server. In this method and system, the electronic mail provider transforms the identification information into a transmission signal, and then transfers the transmission signal to users. Users receive the transmission signal through a receiving terminal, and re-transform the transmission signal into the identification information of electronic mail, then display the identification information on the receiving terminal.

### BRIEF DESCRIPTION OF THE DRAWINGS

The foregoing versions and many of the attendant advantages of this invention will become more readily appreciated as the same become better understood by reference to the following detailed description, when taken in conjunction with the accompanying drawings, wherein:

FIG. 1 shows a block diagram illustrating a conventional dialup connection method for checking new electronic mails;

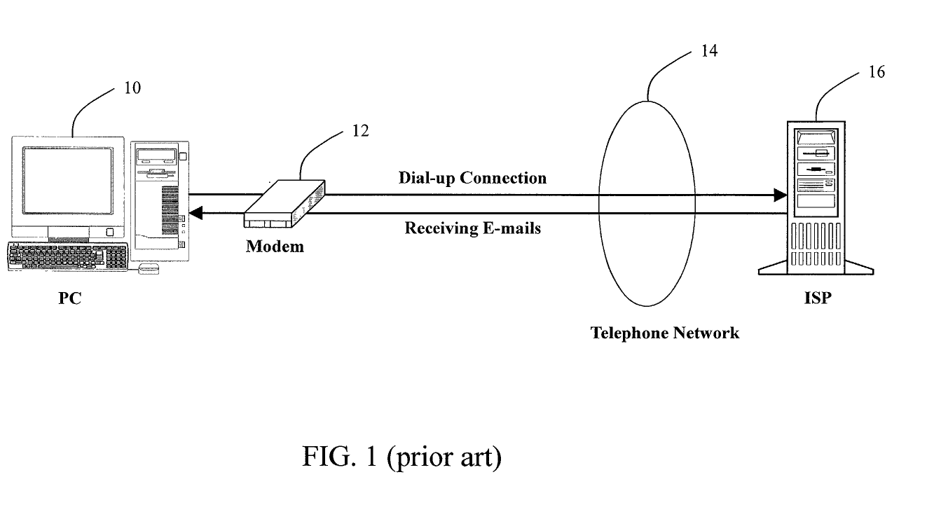

FIG. 2 is a block diagram for a system in one embodiment of the present invention for displaying electronic mails identification information;

FIG. 3 is a sketch map for a system in the other embodiment of the present invention for displaying electronic mails identification information;

FIG. 4 shows a conventional FSK format used in the present invention;

FIG. 5 shows the H/W block diagram illustrating an electronic mail identification of receiving terminal in the present invention;

FIG. 6 is an flowchart of the present invnetion; and

FIG. 7 is a block diagram of the method in the present invention for transferring identification information of electronic mails.

### DESCRIPTION OF THE PREFERRED EMBODIMENT

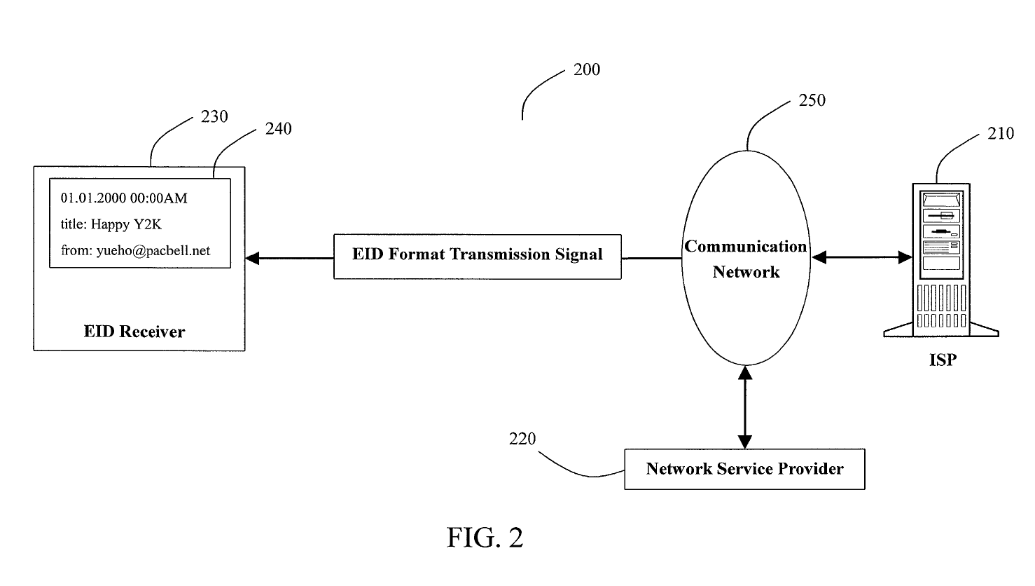

There are some embodiments of the present invention described in greater detail with reference from FIG. 2 to FIG. 7. Nevertheless, it should be realized that the present invention can be practiced in an wide range of other embodiments beside those explicitly described, and the scope of the present invention is expressly not limited except as specified in the accompanying claims. In the following detailed description, several specific details are set forth in order to provide a thorough understanding of the present invention. It will be obvious, however, to one skilled in the art that this invention may be practiced without those specific details.

First of all, it should be noted that some current telephone systems support the services so-called a caller identification (“ID”), or caller ID (“CID”). Such a CID service provides the CID users (i.e., the called party) the information of the caller and display the information on the device of the receiving terminal, such as a telephone set with a liquid crystal display. The caller information generally includes the caller's telephone number. Furthermore, there are some systems supporting the transfer function of words, so as to transfer the caller's name, transferring time, and date. Obviously, by utilizing the caller identification service, it is possible for users to get the information of new electronic mails without actively connecting to the network. The key is to use CID display interface to display the identification information of the electronic mail from the electronic mails provider.

FIG. 2 shows a block diagram of a system 200 in one embodiment of the present invention for displaying electronic mail identification (EID) information. The system 200 comprises an electronic mail provider 210 for providing mail servers, a network service provider 220, such as a telephone company, and an receiving terminal 230 which preferably has a displaying panel 240. In the embodiment, the system 200 is an EID telephone system for transferring the EID information of mail sender from electronic mail provider 210 to the receiving terminal 230 through the network service provider 220. As above network service provider 220 as a telephone company, it may comprise a communication network 250 using a telephone line as a transmission medium. Nevertheless, in the embodiment, besides telephone line, the communication network 250 between electronic mail provider 210 and the receiving terminal 230 may be other wired communication network, such as TV cables, or wireless communication network, such as satellite communication network, mobile communication network systems, etc.

Furthermore, system mentioned above may be regard as a combination of the two systems. One is a system of an electronic mail provider actively transferring identification information of electronic mails, and the other is a system that assisting users in getting the message of a new electronic mail. The former comprises at least a modulating mean and a transfer means. The modulating mean is for transforming identification information of an electronic mail into a transmission signal, and the transfer means is for transferring the transmission signal to a receiving terminal of a user. The latter comprises at least a receiving mean, a demodulating means and a displaying means. The receiving means is for receiving the transmission signal that is transferred from the electronic mail provider. The demodulating means is for transforming the transmission signal into identification information of the electronic mail, and the displaying means is for displaying the identification information.

It should be noted that the system having assisting function may further comprises a connecting device for establishing a connection between the receiving terminal and the electronic mail provider when the receiving terminal is notified to receive EID. Considering user's failure in reading the identification information in time, the operation for transferring the identification information may comprise a suspending step and a re-establishing step. The suspending step is for stopping the connection from the receiving terminal and electronic mail provider 210 that isn't yet established within a set period, while the re-establishing step is for re-establishing the connection with electronic mail provider 210 and transferring the transmission signal after waiting a standby period. In the embodiment, the set period and standby period can be adjustable. Of course, the operation for the system also further comprises automatically transferring the identification information to the receiving terminal as soon as receiving a response message from the receiving terminal.

Besides those mentioned above, the system of transferring identification information further comprises a filtering device. The filtering device would stop transforming the identification information into the transmission signal if the electronic mail corresponds with some predetermined delete conditions, or transforms the identification information into the transmission signal if the electronic mail corresponds with some predetermined permission conditions. Obviously, the filtering device is utilized by electronic mail provider for meeting users' various requirements for transferring identification information.

The filter device also can be built on the receiving terminal. Thus, the filter device is for suspending the transformation of the transmission signal when the identification information is corresponding with some predetermined deletion conditions. Moreover, the filter device also can be for permitting the transformation when the identification information is corresponding with some predetermined permission conditions. Besides, both deletion and permission conditions can be set according to the identification information because of the related-mail messages therein, such as the highlight of electronic mail, receiving date and receiving time, sender's electronic mail address, sender's name, distinctive code (such as telephone number of electronic mail provider), etc. Furthermore, the identification information also can be adjustable. For providing users the more flexibility in receiving the identification information of the electronic mail, the system having assistant function further comprises a switch device for controlling the suspending/permitting operations of the receiving terminal.

The present invention also provides a method for displaying an identification information of an electronic mail that is saved in an electronic mail client's account, and users can view the latest new mails without making any dial-up connection through the Internet to an Internet service provider (ISP). The method comprises the following steps:

First, the electronic mail provider 210 receives an electronic mail.

Second, the identification information data stream of the electronic mail is transformed into a transmission signal in a format, such as FSK (Frequency Shift Keying) or DTMF (Dual Tone Multi-frequency) format, UART (Universal Asynchronous Receiver And Transmitter) or any other transmittable one. Thus, the identification information of the electronic mail may comprise something such as a receiving date and time, a sender's email address, a sender's name, a message title of the electronic mail, and a distinctive code of the ISP's phone number, etc. It should be understand that any one mentioned above is not definitely necessary for the identification information data stream, and others not mentioned above may also be included in the identification information data stream. In addition, the electronic mail provider transfers the transmission signal during a specific period.

Next, the transmission signal which is in conjunction with a first signal and a second signal is transmitted from the electronic mail provider 210 to the receiving terminal 230 through the communication network. The first signal can be a ring signal, a customer-premise-equipment alerting signal (CAS) or null signal. Similarly, the second signal can be a ring signal or null signal.

Next, the receiving terminal 230 receives the transmission signal, the first signal and the second signal.

Moreover, the transmission signal is then transformed back into the identification information data stream of the electronic mail, and the identification information is shown on the display panel 240 of the receiving terminal 230. For example, a greeting message from yueho@pacbell.net with a title “Happy Y2K” transferred at 00:00 AM on the 1st of January, 2000 is display on the display panel 240. Furthermore, besides displaying the image, text, picture and sound of the identification information, the display panel 240 also may output a warning message for indicating arrival of new electronic mails. The warning message can be of a type such as sound, ring, music, blink, text or symbol. Furthermore, all of the identification information can be saved, and showed as a visual message or audio message until the receiving terminal makes a request.

Obviously, the present invention may be regard as a combination of two methods. One method, corresponding to first three steps above, is that an electronic mail provider actively provides users the messages related with new electronic mails. The other one, corresponding to the steps exclusive of first three above, is that users can receive the messages related with the new electronic mail.

Besides, considering that users may be unable to read the identification information in time, the method further comprises a suspending step and a re-establishing step. The suspending step is to suspend the connection between the electronic mail provider and the receiving terminal if it is failed on connection establishment within a specific period. The re-establishing step is to re-establish the connection and transfer the transmission signal after waiting a standby period. Both of the specific and standby periods are adjustable. Besides, the method of the present invention may further comprise a step of automatically transferring the identification information to the receiving terminal as soon as receiving a response from the receiving terminal. The method of the present invention further comprises a step that users can get the electronic mail from the electronic mail provider through network after the users receive the identification information.

For example, in telephone communication system, when the EID receiving terminal on hook receives a phone from the electronic mail provider (electronic identification is transferred), it can automatically become off hook. While, the electronic mail provider confirms the available connection according to a response from the EID receiving terminal, and thereafter transfers the identification information to the EID receiving terminal. However, if the available connection isn't established within a specific period because the EID receiving terminal is off hook, the electronic mail provider may re-establish the connection after waiting a standby period. Besides, when the EID receiving terminal that has functions of call waiting and multi-talker is busy and receive a notification of coming identification information. The EID receiving terminal would notify the user with image or sound, such as “you have a new mail” or beep sound. Thus, users can determine if they are going to receive the new mail or not immediately.

Meanwhile, there are some problems in the method for transferring the related-mail information with the two-terminal phone connection. The problems include cost, advertisement disturbance, and so on. Thus, the filter device also can be built on the receiving terminal. Thus, the method of the present invention comprises a step of filtering. The filtering step is for suspending the transformation of the transmission signal when the identification information is corresponding with some predetermined deletion conditions, or for permitting the transformation of the transmission signal when the identification information is corresponding with some predetermined permission conditions. Certainly, the filtering step can be set in either the electronic mail provider or the receiving terminal.

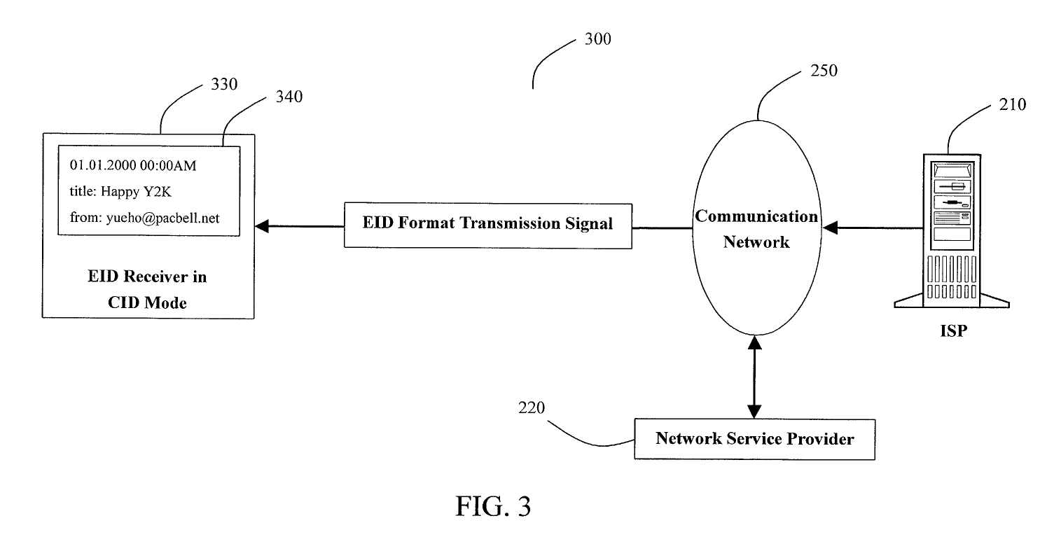

As shown in FIG. 2, the electronic mail provider 210 may work in coordination with the network service provider 220 to transform the identification information of the electronic mail into the transmission signal and to transfer the transmission signal to the receiving terminal 230. The transmission signal can include more information, such as the ISP's advertisements, or other electronic information such as news, stock price, weather, entertainment, business, living information, sport, astrology and traffic. Furthermore users can set to get some electronic messages at a specific period. For example, stock list at 10 o'clock every day. Nevertheless, the electronic mail provider 210 also can utilize the services provided by the network service provider 220, such as a telephone company. The services may include a caller identification (CID) service (shown in FIG. 3).

FIG. 3 shows a block diagram of a system 300 used by another embodiment of the present invention for displaying EID information. In the present embodiment, the electronic mail provider 210 adopts the format provided by the existing CID to transfer messages to the client. By setting the distinctive code, such as phone number, of electronic mail provider 210 in the receiving terminal, and modifying the control circuit therein, such as micro-controller, micro-processor and programming software for modify control circuit, a message corresponding to the notification of new electronic mail arrival from the electronic mail provider 210 , such as “you have new email”, can be shown on the displaying panel 340. The procedure described above is simple. But subjecting to the service provided by the network service provider (such as telephone company), the offering information is relatively fewer.

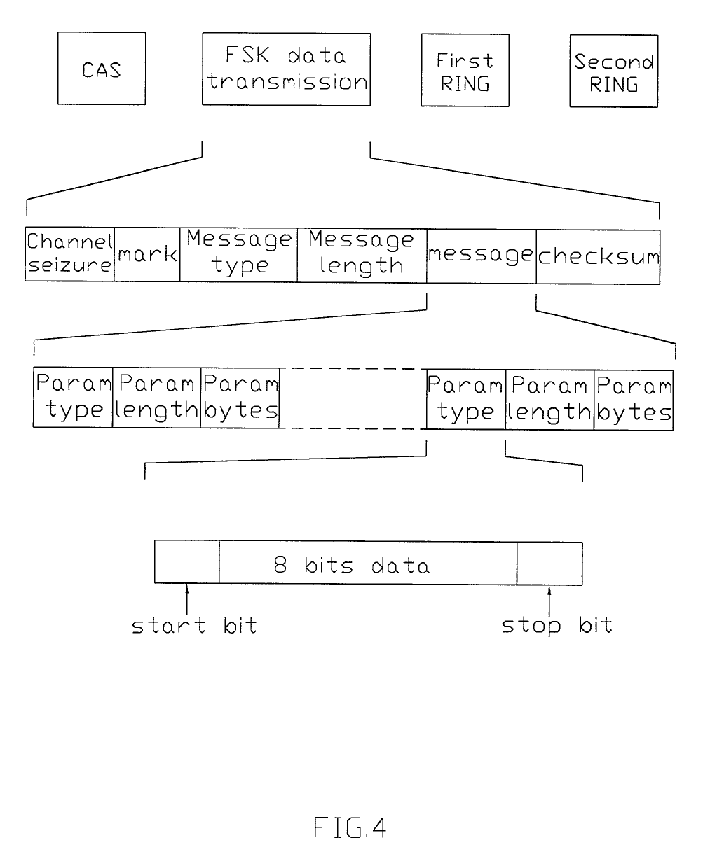

FIG. 4 shows an example of sequentially transferring a CAS signal, an EID message in FSK format and two ring signals. The transferred FSK data stream includes a channel seizure message for notifying the receiving terminal that the EID message is coming after a mark signal containing a series of “1” bits. The mark message is used to identify the head of a data message. The data message includes a string of EID data packet that is composed of 8 bits data, a start bit and a stop bit. The FSK format data stream also includes a checksum signal transferred after the data packet. The checksum message is used to ensure that the receiving terminal has received the data packet correctly. That is, error detection is provided by the use of the checksum word.

Furthermore, the receiving terminal 230, 330(i.e. electronic mail identification receiving terminal) shown respectively in FIGS. 2 and 3 may be an EID phone or an EID adjunct box (AJ-Box). The EID phone and the EID AJ-Box may be a conventional CID phone or a CID adjunct box, which comprising a modified control circuit such as microprocessor, micro controller or programming software for modify circuit.

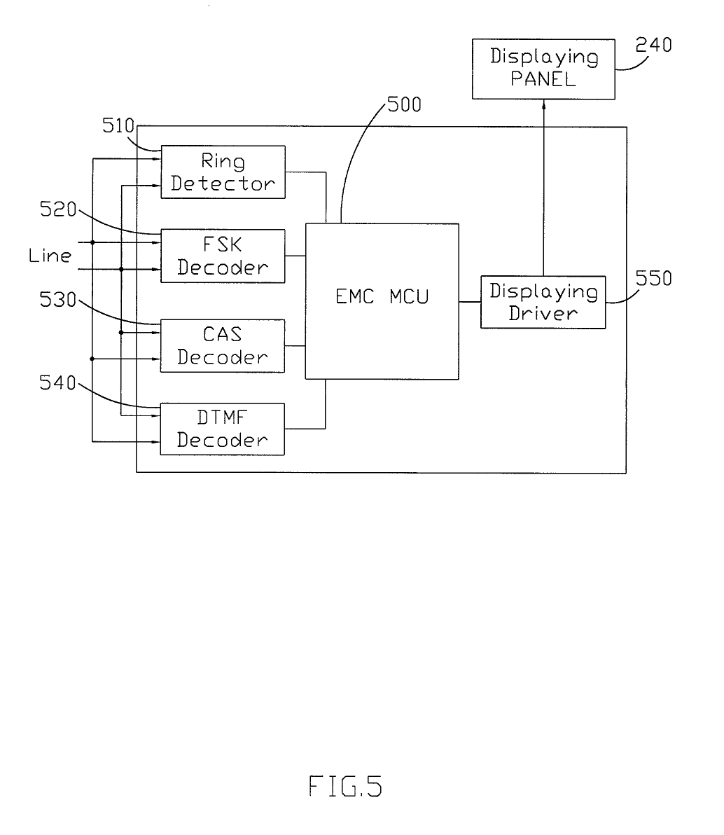

The EID receiving terminal of one embodiment in accordance with the present invention is shown in FIG. 5. EID receiving terminal comprises a control circuit 500 for processing EID data stream, a ring detector 510, a FSK detector 520, a CAS decoder 530 and a DTMF decoder 540 coupled between the line-in and the control circuit 500. The displaying panel 240, having a displaying driver 550, is also included in the block diagram. Furthermore, the embodiment comprises an audio display device (not shown) and a connection device 560. The audio display is for broadcasting the auditory message, while the connection device 560 is for establishing a connection between the receiving terminal and the electronic mail provider when the receiving terminal receives information about existence of EID.

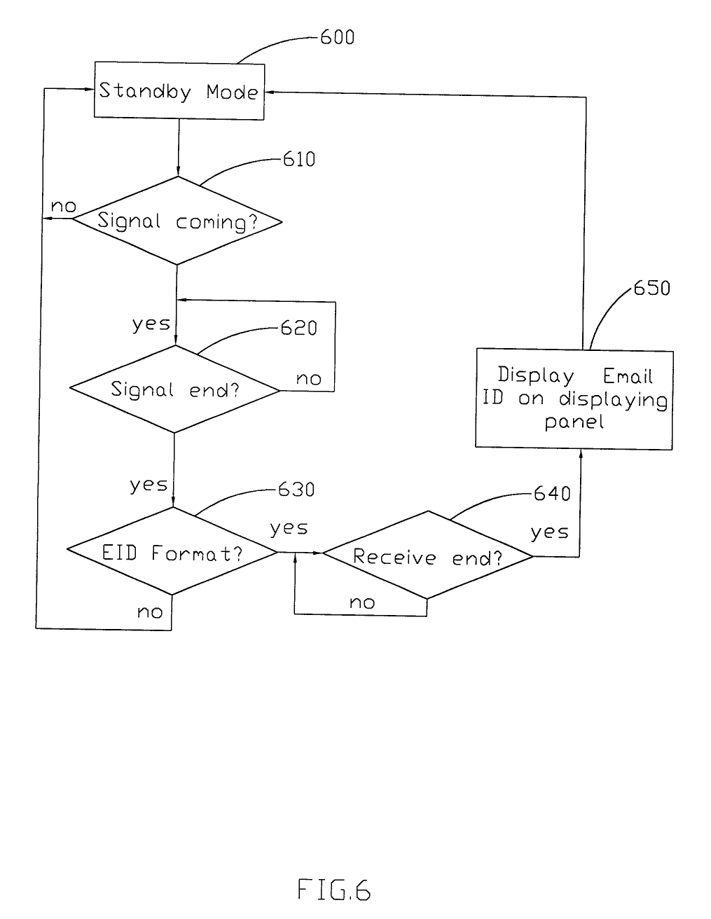

The operating flowchart shown in FIG. 6 is an embodiment the present invention. The EID device is set in a standby mode (Step 600), and continuously detects an incoming message (Step 610). When detecting the incoming message, the control circuit of the EID device may further check the ending of the incoming message (Step 620). Next, the EID device further check whether the format of the message is corresponding with the EID format or not (Step 630). After confirming the message format, the EID device receives the message and check completion of the receiving state (Step 640). Finally, the message is shown on a displaying panel (Step 650) or output in an audible signal.

In addition, the embodiment may further comprise a step of automatically transferring. The automatically transferring step is to transfer a response from the receiving terminal to the electronic mail provider after the receiving terminal receives the transmission signal. The electronic mail provider is required by the response to transfer the corresponding electronic mail to the receiving terminal. However, users also can read the identification information prior to get the corresponding electronic mail that is from the electronic mail provider through a communication network.

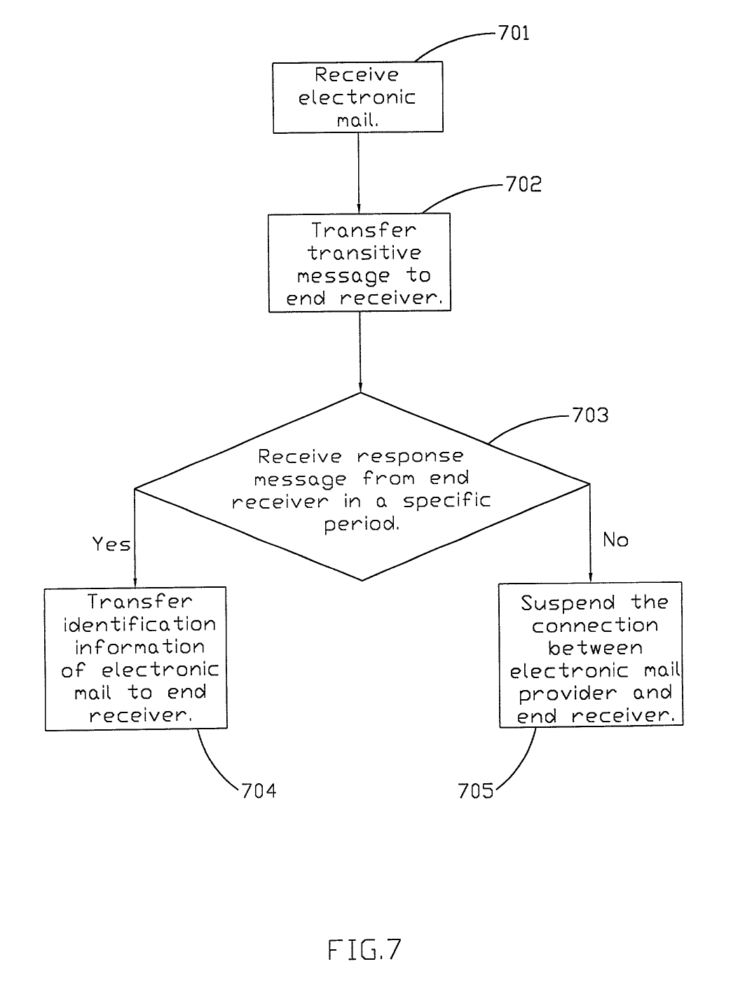

Besides the introduced methods and systems above, the invention also provides a method for transferring identification information of an electronic mail. The method can make sure whether users receive the identification information. As shown in FIG. 7, the method comprises the following steps. First, the electronic provider receives a new electronic mail (step 701). When the new electronic mail arrives, the electronic mail provider transfers the transmission signal to a receiving terminal assigned by users (step 702). Next, when the electronic mail provider receives a response from the receiving terminal within a specific period (step 703), it may transfers identification information of the new electronic mail to the receiving terminal (step 704), otherwise suspends the connection (step 705). Certainly, the method further comprises a re-establishing step. The re-establishing step is for re-establishing the connection between the electronic mail server and the receiving terminal after waiting a standby period. And then the electronic mail provider may transfer the transmission signal again. Furthermore, the method also comprises that users connect to the electronic mail provider to get the new mails after they receive the transmission signal. Additionally, both the specific and standby periods are adjustable, and the response may only be a message resulting from the state variation of the receiving terminal (such as on hook state switches to off hook state) without any specific format.

Accordingly, the system and method of the invention are to automatically transfer and display identification information of new electronic mail, to and on, a receiving terminal. The displaying can be an audible message or a visible message for indicating the arrivals of new E-mails and enabling users checking the mails in time. Moreover, the invention further provides the functions for checking users options prior to transferring the identification information. Obviously, by using the present invention, users can receive the new mails without actively starting computer and connecting network, thus raise efficiency and save all costs.

Although specific embodiment has been illustrated and described, it will be obvious to those skilled in the art that various modifications may be made without departing from what is intended to be limited solely by the appended claims.

What is claimed is:

1. A method for actively providing users with the message of a new mail by an electronic mail provider, said method comprising:
creating an identification information of said new mail as detecting the appearance of said new mail;
transforming said identification information into a transmission signal; and
transferring said transmission signal to a receiving terminal.

2. The method according to claim 1 further comprising automatically sending said receiving terminal said identification information of said new mail as soon as receiving a response from said receiving terminal.

3. The method according to claim 1 further comprising suspending a connection between said electronic mail provider and said receiving terminal by detecting a first deadline of establishing said connection.

4. The method according to claim 1 further comprising re-establishing said connection and thereafter transferring said transmission signal after waiting a second deadline.

5. The method according to claim 1 further comprising said users receiving said new mail from said electronic mail provider through a telecommunication network as soon as said users receiving said identification information.

6. The method according to claim 1, wherein said electronic mail provider transfers said transmission signal during a specific period.

7. The method according to claim 1, wherein said transmission signal further comprises advertisement information of said electronic maid provider.

8. The method according to claim 1, wherein said electronic mail provider transforms said identification information into said transmission signal and transfers said transmission signal by using an identification communication protocol for a caller terminal.

9. The method according to claim 1, wherein said identification information comprises a message subject for said new mail.

10. The method according to claim 1, wherein said identification information comprises a receiving date and a receiving time.

11. The method according to claim 1, wherein said identification information comprises an electronic mail address of a sender.

12. The method according to claim 1, wherein said identification information comprises a name of said sender.

13. The method according to claim 1, wherein said identification information comprises a distinctive code.

14. The method according to claim 13, wherein said distinctive code comprises a telephone number of said electronic mail provider.

15. The method according to claim 1, wherein said transmission signal is in a frequency shift key format.

16. The method according to claim 1, wherein said transmission signal is in a dual-tone multi-frequency format.

17. The method according to claim 1, wherein said transmission signal is in a universal asynchronous receive and transmission format.

18. The method according to claim 1 further comprising a filtering step prior to transferring said transmission signal, said filtering step is used for suspending said transmission signal corresponding with a plurality of set deletion conditions for said new mail.

19. The method according to claim 1 further comprising a filtering step prior to transferring said transmission signal, said filtering step is used for transferring said transmission signal corresponding with a plurality of set permission conditions for said new mail.

20. A method for users to obtain a message from a new electronic mail, said method comprising:
receiving a transmission signal actively transferred from an electronic mail provider through a receiving terminal; and
transforming said transmission signal into an identification information, said identification information is related to said new electronic mail that is not yet received or read by said users.

21. The method according to claim 20 further comprising automatically transferring a response from said receiving terminal to said electronic mail provider after receiving said transmission signal, and said step of automatically transferring used for requesting said electronic mail provider to automatically transfer said identification information to said receiving terminal.

22. The method according to claim 20 further comprising displaying said identification information for notifying said users.

23. The method according to claim 20 further comprising receiving said electronic mail from said electronic mail provider through a telecommunication network after reading said identification information by said users.

24. The method according to claim 20, wherein said identification information comprises a message subject for said electronic mail.

25. The method according to claim 20, wherein said identification information comprises a receiving date and a receiving time.

26. The method according to claim 20, wherein said identification information comprises an electronic mail address of a sender.

27. The method according to claim 20, wherein said identification information comprises a name of a sender.

28. The method according to claim 20, wherein said identification information comprises a distinctive code.

29. The method according to claim 28, wherein said distinctive code comprises a telephone number of said electronic mail provider.

30. The method according to claim 20, wherein said transmission signal is in a frequency shift key format.

31. The method according to claim 20, wherein said transmission signal is in a dual-tone multi-frequency format.

32. The method according to claim 20, wherein said transmission signal is in a universal asynchronous receiving and transferring format.

33. The method according to claim 20, wherein said receiving terminal comprises an electronic mail identification phone.

34. The method according to claim 20, wherein said receiving terminal comprises an electronic mail identification assistant device.

35. The method according to claim 20, wherein said receiving terminal comprises a caller identification phone that has electronic mail identification function.

36. The method according to claim 20, wherein said receiving terminal comprises a caller identification assistant device that has electronic identification function.

37. The method according to claim 20 further comprising a filtering step prior to transferring said transmission signal, said filtering step is used for suspending said transmission signal corresponding with a plurality of set deletion conditions.

38. The method according to claim 20 further comprising a filtering step prior to transferring said transmission signal, said filtering step is used for transferring said transmission signal corresponding with a plurality of set permission conditions.

39. The method according to claim 20 further comprising a switch device for controlling operation of said receiving terminal, said receiving terminal receiving said transmission signal when said switch device is in a on state, and said receiving terminal stopping receiving said transmission signal when said switch device is in an off state.

40. A system for a electronic mail provider to actively transferring an identification information of an electronic mail, said system comprising:
modulating means for transforming said identification information into a transmission signal; and transferring means for transferring said transmission signal to a receiving terminal of a user.

41. The system of claim 40 further comprising a mail server which is set in said electronic mail provider, wherein said mail server is used for receiving and transferring said electronic mails.

42. The system of claim 40, wherein said electronic mail provider transforms said identification information into said transmission and transfers said transmission signal by utilizing an communication protocol of identification service by a caller terminal.

43. The system of claim 40, wherein said electronic mail provider transfers said transmission signal during a specific period.

44. The system of claim 40, wherein said identification information comprises a message subject of said electronic mail.

45. The system of claim 40, wherein said identification information comprises a date and a time.

46. The system of claim 40, wherein said identification information comprises a sender's electronic mail address.

47. The system of claim 40, wherein said identification information comprises a sender's name.

48. The system of claim 40, wherein said identification information comprises a distinctive code.

49. The system of claim 48, wherein said distinctive code comprises a telephone number of said electronic mail provider.

50. The system of claim 40 further comprising a filtering device for suspending said transmission signal corresponding with a plurality of set deletion conditions prior to transferring said transmission signal.

51. The method of claim 40 further comprising a filtering device for transferring said transmission signal corresponding with a plurality of set permission conditions prior to transferring said transmission signal.

52. A system for assisting a user to obtain a message of a new electronic mail, said system comprising:
receiving means for receiving a transmission signals which is transferred from an electronic mail provider;
analyzing means for transforming said transmission signals into an identification information of said electronic mail; and
displaying means for displaying said identification information.

53. The system of claim 52 further comprising a storage device for storing said identification information.

54. The system of claim 52, wherein said electronic mail provider translates said identification information and transfers said transmission signal by utilizing a communication protocol of an identification by a caller terminal.

55. The system of claim 52, wherein said identification information comprises a message subject of said electronic mail.

56. The system of claim 52, wherein said identification information comprises a date and a time.

57. The system of claim 52, wherein said identification information comprises a sender's electronic mail address.

58. The system of claim 52, wherein said identification information comprises a sender's name.

59. The system of claim 52, wherein said identification information comprises a distinctive code.

60. The system of claim 59, wherein said distinctive code comprises a telephone number of said electronic mail provider.

61. The system according to claim 52, wherein said receiving terminal comprises an electronic mail identification phone.

62. The system of claim 52, wherein said receiving terminal comprises an electronic mail identification assistant device.

63. The system of claim 52, wherein said receiving terminal an identification phone of a caller terminal which has electronic mail identification function.

64. The system of claim 52, wherein said receiving comprises a identification assistant device of a caller terminal that has electronic identification function.

65. The system of claim 52, wherein said displaying means comprises a displaying plane.

66. The system of claim 52, wherein said displaying means comprises an audio broadcasting device.

67. The system of claim 52 further comprising a filtering device for suspending said transmission signal corresponding with a plurality of set deletion conditions prior to transferring said transmission signal.

68. The method of claim 52 further comprising a filtering device for transferring said transmission signal corresponding with a plurality of set permission conditions prior to transferring said transmission signal.

69. The system of claim 52 further comprising a switch device for controlling operation of said receiving terminal, and said receiving terminal receiving said transmission signal when said switch device is on and stopping receiving said transmission signal when said switch device is off.

70. The system of claim 52 further comprising a connecting device for connecting said receiving terminal and said electronic mail provider when said transmission signal is received.

71. A method for transferring an identification information of an electronic mail, said method comprising:
transferring said identification information from an electronic mail provider to an receiving terminal which is predetermined by a corresponding user of said electronic mail;
transferring an identification information of said electronic mail to said receiving terminal when a response message from said receiving terminal is received within a predetermined period; and
suspending a connection between said electronic mail provider and said receiving terminal when no said response message is received within said predetermined period.

72. The method according to claim 71 further comprising a step of reestablishing said connection between said electronic mail provider and said receiving terminal after suspending said connection and thereafter waiting a standby period.

73. The method according to claim 71 further comprising said user connecting to said electronic mail provider for getting said electronic mail after receiving said identification information.

74. The method according to claim 71 further comprising a step of storing said identification information on said receiving terminal for displaying when said user queries.

75. The method according to claim 71, wherein said electronic mail provider transfers said transmission signal during a specific period.

76. The method according to claim 71, wherein said identification information comprises a message subject of said electronic mail.

77. The method according to claim 71, wherein said identification information comprises a date and a time.

78. The method according to claim 71, wherein said identification information comprises a sender's electronic mail address.

79. The method according to claim 71, wherein said identification information comprises a sender's name.

80. The method according to claim 71, wherein said identification information comprises a distinctive code.

81. The method according to claim 80, wherein said distinctive code comprises a telephone number of said electronic mail provider.

82. The method according to claim 71, wherein hardware of said receiving terminal has a caller identification function.

83. The method according to claim 71, wherein said receiving terminal further comprises a connecting device for establishing a connection between said receiving terminal and said electronic mail provider.
